(19) United States
(12) Patent Application Publication
(10) Pub. No.: US 2017/0050418 A1
(43) Pub. Date: Feb. 23, 2017

(54) Thermoplastic Elastomeric Films and the Method of Manufacturing Same

(71) Applicant: ExxonMobil Chemical Patents Inc., Baytown, TX (US)

(72) Inventor: Hari P. Nadella, Gainsville, GA (US)

(21) Appl. No.: 15/306,725

(22) PCT Filed: Apr. 24, 2015
(86) PCT No.: PCT/US2015/027621

§ 371 Date: Oct. 25, 2016

Related U.S. Application Data
(60) Provisional application No. 62/005,226, filed on May 30, 2014.

(30) Foreign Application Priority Data
Aug. 20, 2014 (EP) 14181532.4

(51) Int. Cl. B32B 27/08; B29C 47/06; B29C 47/88; B29C 55/28; B60C 1/00; B32B 7/12; B32B 27/26; B32B 27/34; B32B 27/32; B29C 47/00; B29D 30/06

(52) U.S. Cl. CPC B32B 27/08; B29C 47/0004; B29C 47/065; B29C 47/0057; B29C 47/8835; B29C 55/28; B29C 47/0021; B29D 30/0681; B32B 7/12; B32B 27/26; B32B 27/34; B32B 27/32; B60C 1/0008; B29K 2021/003

(57) ABSTRACT

A process for forming a film for dynamically vulcanized alloy comprising at least one elastomer dispersed within a thermoplastic resin domain wherein the film is characterized by low shrinkage rates after completion of the formation of the extruded film. The film has a shrinkage rate, measured at not earlier than 96 hours after formation of the film, of less than 1.5% relative to the film width as measured just after film formation. During formation of the film, the extruded film is subjected to a cooling rate of less than 97° C. per second and the frost line of the extruded film is greater than 135 mm.

### PRIORITY

This invention claims priority to and the benefit of U.S. Ser. No. 62/005,226, filed May 30, 2014, and EP application 14181532.4, filed Aug. 20, 2014.

### FIELD OF THE INVENTION

The present invention relates to thermoplastic elastomeric films. More particularly, the present invention is directed to thermoplastic elastomeric films and the method of extruding such films wherein the properties of the film are fixed at the time of extrusion.

### BACKGROUND OF THE INVENTION

The present invention is related to thermoplastic elastomeric compositions particularly useful for tire and other industrial rubber applications, reinforced or otherwise, that require impermeability characteristics.

EP 0 722 850 B1 discloses a low-permeability thermoplastic elastomeric composition that is excellent as an innerliner in pneumatic tires. This composition comprises a low permeability thermoplastic in which is dispersed a low permeability rubber. EP 0 969 039 A1 discloses a similar composition and teaches dispersion of the small particle sized rubber in the thermoplastic domain is important to achieve acceptable durability of the resulting composition. These thermoplastic elastomers are also known as dynamically vulcanized alloys (“DVAs”) when the compositions are prepared by mixing the ingredients at a temperature which is at or above the curing temperature of the elastomer so that the elastomer is at least partially cured during mixing of the material.

For DVAs, the unique characteristic of the dynamically cured compositions is that, notwithstanding the fact that the elastomer component may be fully cured, the compositions can be processed and reprocessed by conventional thermoplastic processing techniques such as film blowing, extrusion, injection molding, compression molding, etc. In other words, the DVA has a number of characteristics of the thermoplastic material that forms the domain of the composite material. Such common characteristics would suggest to a DVA user/manufacturer that the DVA material may treated in the same manner as a thermoplastic in preparing products, such a films or sheets of DVA material for use as air barrier layers in various products such as tires, hoses, or bladders as disclosed in the above referenced EP publications.

Thermoplastic films have been formed by melting the material in a melt screw extruder, extruding the melted material from a die to form a sheet or tube, and then cooling to solidification. During solidification, the film may be subjected to orientation of the thermoplastic crystals. One method of orientation for cast films, known as sequential biaxial orientation, involves drawing the film in the longitudinal direction using a difference in peripheral speed between heating rolls, and then drawn in the width direction with the film held by a clip. In another method, known as simultaneous biaxial orientation, the film held by a clip is substantially simultaneously drawn in the longitudinal direction and the width direction. Known draw ratios in such drawing processes have a range of 2.0 to 5.5 times for each direction. Drawing speeds for thermoplastic films are in the range of 1,000 to 200,000%/min, and the drawing temperature is typically between the glass transition temperature of the material and a temperature 40° C. higher than the glass transition temperature. Drawing may be performed several times for each direction.

Another method of orienting extruded thermoplastic film is by blown film process subjecting the film to air flow to simultaneously cool blow and stretch the extruded film. All blowing and stretching of the film ideally occurs before the film has reached its frost line; the frost line is defined as the point where a noticeable change in film melt temperature is measured (where the phase transition from melt to solid begins). After the film has passed the frost line, orientation of the thermoplastic resin in the film is generally fixed.

One known characteristic of thermoplastic material film is shrinkage of the film after blowing or casting of the material. This shrinkage is due to recrystallization of the thermoplastic material upon cooling. Attempts have been made in the past to reduce shrinkage, or fix the final dimension of the film at the time of extrusion. The majority of these techniques involve maintaining the maximum fixed dimension obtained at the frost line.

For DVA materials, while the material may exhibit some conventional thermoplastic characteristics, the presence of the dispersed elastomeric particles affects the ability to adopt conventional thermoplastic processing techniques. Applicants have found that when using thermoplastic film extrusion employing conventional techniques to fix the film width, the film was subject to aged shrinkage rates of greater than 3%. This shrinkage rate was found to negatively impact the performance of the film when used in an article. It was determined that changes to processing techniques and machinery due to the elastomer content in the film was required. The present invention is directed to addressing this film formation issue.

### SUMMARY OF THE INVENTION

The present invention is directed to thermoplastic elastomeric films having improved aging characteristics and a method of obtaining such a film.

Disclosed herein is a process for forming a film of a dynamically vulcanized alloy comprising at least one elastomer dispersed within a thermoplastic resin domain wherein the film is characterized by low shrinkage rates after formation of the extruded film. In any embodiment, during formation of the film, the extruded film is subjected to a cooling rate of less than 97° C. per second and the frost line of the extruded film is greater than 135 mm. The film in any embodiment has a shrinkage rate, measured at not earlier than 96 hours after formation of the film, of less than 1.5%. The shrinkage rate percentage is calculated as the difference between i) the maximum width of the film past the film frost line measured just after formation and ii) the maximum width of the film at a time measured not earlier than ninety-six hours after formation. In any embodiment of the invention, the shrinkage rate is not more than 2.0% when the second measurement of the film is four weeks after film formation.

In any embodiment, during film formation, the blow up ratio is not more than 2.8, alternatively in the range of 1.9 to 2.8, and the draw down ratio is not more than 6.0, alternatively in the range of 2.8 to 6.0.

The extruded film may be a multi-layered extruded laminate of different materials or a multi-layered extruded laminate wherein the dynamically vulcanized alloy is extruded through multiple adjacent extrusion rings to achieve the desired film thickness.

### BRIEF DESCRIPTION OF THE DRAWINGS

The invention will be described by way of example and with reference to the accompanying drawing in which:

FIG. 1 illustrates a conventional thermoplastic extruder film blowing process;

FIG. 2 is a graph showing results of extruded film shrinkage rate experiments; and

FIG. 3 is a graph showing the relationship of cooling rate and shrinkage.

### DETAILED DESCRIPTION OF THE INVENTION

The present invention is directed to thermoplastic elastomeric films having improved aging characteristics and a method of obtaining such a film. The films of the present invention have improved aged shrinkage characteristics, providing for improved final product performance of articles incorporating the films. The desired reduced shrinkage characteristics are obtained by an improved process of extruding and drawing the blown film as described below.

Various specific embodiments, versions, and examples of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

### DEFINITIONS

Definitions applicable to the presently described invention are as described below.

Polymer may be used to refer to homopolymers, copolymers, interpolymers, terpolymers, etc. Likewise, a copolymer may refer to a polymer comprising at least two monomers, optionally with other monomers. When a polymer is referred to as comprising a monomer, the monomer is present in the polymer in the polymerized form of the monomer or in the polymerized form of a derivative from the monomer (i.e., a monomeric unit). However, for ease of reference the phrase comprising the (respective) monomer or the like is used as shorthand. Likewise, when catalyst components are described as comprising neutral stable forms of the components, it is well understood by one skilled in the art, that the ionic form of the component is the form that reacts with the monomers to produce polymers.

Elastomer refers to any polymer or composition of polymers consistent with the ASTM D1566 definition: “a material that is capable of recovering from large deformations, and can be, or already is, modified to a state in which it is essentially insoluble, if vulcanized, (but can swell) in a solvent.” Elastomers are often also referred to as rubbers; the term elastomer may be used herein interchangeably with the term rubber.

The term “phr” is parts per hundred rubber or “parts”, and is a measure common in the art wherein components of a composition are measured relative to a total of all of the elastomer components. The total phr or parts for all rubber components, whether one, two, three, or more different rubber components is present in a given recipe is normally defined as 100 phr. All other non-rubber components are ratioed against the 100 parts of rubber and are expressed in phr. This way one can easily compare, for example, the levels of curatives or filler loadings, etc., between different compositions based on the same relative proportion of rubber without the need to recalculate percentages for every component after adjusting levels of only one, or more, component(s).

Isoolefin refers to any olefin monomer having at least one carbon having two substitutions on that carbon. Multiolefin refers to any monomer having two or more double bonds. In a preferred embodiment, the multiolefin is any monomer comprising two conjugated double bonds such as a conjugated diene like isoprene.

Isobutylene based elastomer or polymer refers to elastomers or polymers comprising at least 70 mol % repeat units from isobutylene.

### Elastomer

Useful elastomeric compositions for this invention include elastomers derived of at least one C₄ to C₇ isoolefin monomer component and at least one multiolefin monomer component. The isoolefin is present in a range from 70 to 99.5 wt % by weight of the total monomers in any embodiment, or 85 to 99.5 wt % in any embodiment. The multiolefin derived component is present in amounts in the range of from 30 to about 0.5 wt % in any embodiment, or from 15 to 0.5 wt % in any embodiment, or from 8 to 0.5 wt % in any embodiment.

The isoolefin is a C₄ to C₇ compound; non-limiting examples of which are compounds such as isobutylene, 2-methyl-1-butene, 3-methyl-1-butene, 2-methyl-2-butene, 1-butene, 2-butene, methyl vinyl ether, indene, vinyltrimethylsilane, hexene, and 4-methyl-1-pentene. The multiolefin is a C₄ to C₁₄ multiolefin such as isoprene, butadiene, 2,3-dimethyl-1,3-butadiene, myrcene, 6,6-dimethyl-fulvene, hexadiene, cyclopentadiene, and piperylene. Other polymerizable monomers such as styrene and dichlorostyrene are also suitable for homopolymerization or copolymerization.

Preferred elastomers useful in the practice of this invention include isobutylene-based copolymers. As stated above, an isobutylene based elastomer or a polymer refers to an elastomer or a polymer comprising at least 70 mol % repeat units from isobutylene and at least one other polymerizable unit. The isobutylene-based copolymer may or may not be halogenated.

In any embodiment of the invention, the elastomer may be a butyl-type rubber or branched butyl-type rubber, especially halogenated versions of these elastomers. Useful elastomers are unsaturated butyl rubbers such as copolymers of olefins or isoolefins and multiolefins. Non-limiting examples of unsaturated elastomers useful in the method and composition of the present invention are poly(isobutylene-co-isoprene), polyisoprene, polybutadiene, polyisobutylene, poly(styrene-co-butadiene), natural rubber, star-branched butyl rubber, and mixtures thereof. Useful elastomers in the present invention can be made by any suitable means known in the art, and the invention is not herein limited by the method of producing the elastomer. The butyl rubber polymer of the invention is obtained by reacting isobutylene with 0.5 to 8 wt % isoprene, or reacting isobutylene with 0.5 wt % to 5.0 wt % isoprene—the remaining weight percent of the polymer being derived from isobutylene.

Elastomeric compositions of the present invention may also comprise at least one random copolymer comprising a C₄ to C₇ isoolefin and an alkylstyrene comonomer. The isoolefin may be selected from any of the above listed C₄ to C₇ isoolefin monomers, and is preferably an isomonoolefin, and in any embodiment may be isobutylene. The alkylstyrene may be para-methylstyrene, containing at least 80%, more alternatively at least 90% by weight of the para-isomer. The random copolymer may optionally include functionalized interpolymers. The functionalized interpolymers have at least one or more of the alkyl substituents groups present in the styrene monomer units; the substituent group may be a benzylic halogen or some other functional group. In any embodiment, the polymer may be a random elastomeric copolymer of a C₄ to C₆ α-olefin and an alkylstyrene comonomer. The random comonomer may optionally include functionalized interpolymers wherein at least one or more of the alkyl substituents groups present in the styrene monomer units contain benzylic halogen or some other functional group. In any embodiment, up to 60 mol % of the substituted styrene present in the random polymer structure may be functionalized. Alternatively, in any embodiment, from 0.1 to 5 mol % or 0.2 to 3 mol % of the substituted styrene present may be functionalized.

The functional group may be halogen or some other functional group which may be incorporated by nucleophilic substitution of any benzylic halogen with other groups such as carboxylic acids; carboxy salts; carboxy esters, amides and imides; hydroxy; alkoxide; phenoxide; thiolate; thioether; xanthate; cyanide; cyanate; amino and mixtures thereof. These functionalized isomonoolefin copolymers, their method of preparation, methods of functionalization, and cure are more particularly disclosed in U.S. Pat. No. 5,162,445.

In any embodiment, the elastomer comprises random polymers of isobutylene and 0.5 to 20 mol % para-methylstyrene wherein up to 60 mol % of the methyl substituent groups present on the benzyl ring is functionalized with a halogen such bromine or chlorine, an acid, or an ester. In any embodiment, the functionality is selected such that it can react or form polar bonds with functional groups present in the matrix polymer, for example, acid, amino or hydroxyl functional groups, when the polymer components are mixed at high temperatures.

Brominated poly(isobutylene-co-p-methylstyrene) “BIMSM” polymers useful in the present invention generally contain from 0.1 to 5 mol % of bromomethylstyrene groups relative to the total amount of monomer derived units in the copolymer. In any embodiment of the invention using BIMSM, the amount of bromomethyl groups is from 0.5 to 3.0 mol %, or from 0.3 to 2.8 mol %, or from 0.4 to 2.5 mol %, or from 0.5 to 2.0 mol %, wherein a desirable range for the present invention may be any combination of any upper limit with any lower limit. Also in accordance with the invention, the BIMSM polymer has either 1.0 to 2.0 mol % bromomethyl groups, or 1.0 to 1.5 mol % of bromomethyl groups. Expressed another way, exemplary BIMSM polymers useful in the present invention contain from 0.2 to 10 wt % of bromine, based on the weight of the polymer, or from 0.4 to 6 wt % bromine, or from 0.6 to 5.6 wt %. Useful BIMSM polymers may be substantially free of ring halogen or halogen in the polymer backbone chain. In any embodiment, the random polymer is a polymer of C₄ to C₇ isoolefin derived units (or isomonoolefin), para-methylstyrene derived units and para-(halomethylstyrene) derived units, wherein the para-(halomethylstyrene) units are present in the polymer from 0.5 to 2.0 mol % based on the total number of para-methylstyrene, and wherein the para-methylstyrene derived units are present from 5 to 15 wt %, or 7 to 12 wt %, based on the total weight of the polymer. In any embodiment, the para-(halomethylstyrene) is para-(bromomethylstyrene).

### Thermoplastic Resin

For purposes of the present invention, a thermoplastic (alternatively referred to as thermoplastic resin) is a thermoplastic polymer, copolymer, or mixture thereof having a Young's modulus of more than 200 MPa at 23° C. The resin should have a melting temperature of about 170° C. to about 260° C., preferably less than 260° C., and most preferably less than about 240° C. By conventional definition, a thermoplastic is a synthetic resin that softens when heat is applied and regains its original properties upon cooling.

Such thermoplastic resins may be used singly or in combination and generally contain nitrogen, oxygen, halogen, sulfur or other groups capable of interacting with an aromatic functional groups such as halogen or acidic groups. Suitable thermoplastic resins include resins selected from the group consisting or polyamides, polyimides, polycarbonates, polyesters, polysulfones, polylactones, polyacetals, acrylonitrile-butadiene-styrene resins (ABS), polyphenyleneoxide (PPO), polyphenylene sulfide (PPS), polystyrene, styrene-acrylonitrile resins (SAN), styrene maleic anhydride resins (SMA), aromatic polyketones (PEEK, PED, and PEKK), ethylene copolymer resins (EVA or EVOH) and mixtures thereof.

Suitable polyamides (nylons) comprise crystalline or resinous, high molecular weight solid polymers including copolymers and terpolymers having recurring amide units within the polymer chain. Polyamides may be prepared by polymerization of one or more epsilon lactams such as caprolactam, pyrrolidione, lauryllactam and aminoundecanoic lactam, or amino acid, or by condensation of dibasic acids and diamines Both fiber-forming and molding grade nylons are suitable. Examples of such polyamides are polycaprolactam (nylon-6), polylauryllactam (nylon-12), polyhexamethyleneadipamide (nylon-6,6) polyhexamethyleneazelamide (nylon-6,9), polyhexamethylenesebacamide (nylon-6,10), polyhexamethyleneisophthalamide (nylon-6, IP) and the condensation product of 11-amino-undecanoic acid (nylon-11). Commercially available polyamides may be advantageously used in the practice of this invention, with linear crystalline polyamides having a softening point or melting point between 160 and 260° C. being preferred.

Suitable polyesters which may be employed include the polymer reaction products of one or a mixture of aliphatic or aromatic polycarboxylic acids esters of anhydrides and one or a mixture of diols. Examples of satisfactory polyesters include poly (trans-1,4-cyclohexylene C₂₋₆ alkane dicarboxylates such as poly(trans-1,4-cyclohexylene succinate) and poly (trans-1,4-cyclohexylene adipate); poly (cis or trans-1,4-cyclohexanedimethylene) alkanedicarboxylates such as poly(cis-1,4-cyclohexanedimethylene) oxlate and poly-(cis-1,4-cyclohexanedimethylene) succinate, poly (C₂₋₄ alkylene terephthalates) such as polyethyleneterephthalate and polytetramethylene-terephthalate, poly (C₂₋₄ alkylene isophthalates such as polyethyleneisophthalate and polytetramethylene-isophthalate and like materials. Preferred polyesters are derived from aromatic dicarboxylic acids such as naphthalenic or phthalic acids and C₂ to C₄ diols, such as polyethylene terephthalate and polybutylene terephthalate. Preferred polyesters will have a melting point in the range of 160° C. to 260° C.

Poly(phenylene ether) (PPE) resins which may be used in accordance with this invention are well known, commercially available materials produced by the oxidative coupling polymerization of alkyl substituted phenols. They are generally linear, amorphous polymers having a glass transition temperature in the range of 190° C. to 235° C.

Ethylene copolymer resins useful in the invention include copolymers of ethylene with unsaturated esters of lower carboxylic acids as well as the carboxylic acids per se. In particular, copolymers of ethylene with vinylacetate or alkyl acrylates for example methyl acrylate and ethyl acrylate can be employed. These ethylene copolymers typically comprise about 60 to about 99 wt % ethylene, preferably about 70 to 95 wt % ethylene, more preferably about 75 to about 90 wt % ethylene. The expression “ethylene copolymer resin” as used herein means, generally, copolymers of ethylene with unsaturated esters of lower (C₁-C₄) monocarboxylic acids and the acids themselves; e.g., acrylic acid, vinyl esters or alkyl acrylates. It is also meant to include both “EVA” and “EVOH”, which refer to ethylene-vinylacetate copolymers, and their hydrolyzed counterpart ethylene-vinyl alcohols.

### Thermoplastic Elastomeric Composition

At least one of any of the above elastomers and at least one of any of the above thermoplastics are blended to form a dynamically vulcanized alloy. The term “dynamic vulcanization” is used herein to connote a vulcanization process in which the vulcanizable elastomer is vulcanized in the presence of a thermoplastic under conditions of high shear and elevated temperature. As a result, the vulcanizable elastomer is simultaneously at least partially crosslinked and preferably becomes dispersed as fine sub micron size particles of a “micro gel” within the thermoplastic. The resulting material is often referred to as a dynamically vulcanized alloy (“DVA”).

Dynamic vulcanization is effected by mixing the ingredients at a temperature which is at or above the curing temperature of the elastomer, and also above the melt temperature of the thermoplastic component, in equipment such as roll mills, Banbury™ mixers, continuous mixers, kneaders or mixing extruders, e.g., Buss kneaders, twin or multiple screw extruders. The unique characteristic of the dynamically cured compositions is that, notwithstanding the fact that the elastomer component may be fully cured, the compositions can be processed and reprocessed by conventional thermoplastic processing techniques such as film blowing, extrusion, injection molding, compression molding, etc. Scrap or flashing can also be salvaged and reprocessed; those skilled in the art will appreciate that conventional elastomeric thermoset scrap, comprising only elastomer polymers, cannot readily be reprocessed due to the cross-linking characteristics of the vulcanized polymer.

Preferably the thermoplastic resin may be present in an amount ranging from about 10 to 98 wt %, preferably from about 20 to 95 wt %, and the elastomer may be present in an amount ranging from about 2 to 90 wt %, preferably from about 5 to 80 wt %, based on the polymer blend. For elastomeric-rich blends, the amount of thermoplastic resin in the polymer blend is in the range of 45 to 10 wt % and the elastomer is present in the amount of 90 to 55 wt %.

The elastomer may be present in the composition in a range up to 90 wt % in any embodiment, or up to 80 wt % in any embodiment, or up to 70 wt % in any embodiment. In the invention, the elastomer may be present from at least 2 wt %, and from at least 5 wt % in another embodiment, and from at least 5 wt % in yet another embodiment, and from at least 10 wt % in yet another embodiment. A desirable embodiment may include any combination of any upper wt % limit and any lower wt % limit.

In any embodiment of the present invention, the primary vulcanizable elastomer and the primary thermoplastic resin are selected wherein there is no common monomer from which the elastomer and the thermoplastic resin are formed. For example, a thermoplastic elastomer comprising ethylene-propylene elastomeric copolymers and ethylene based resins, such as polyethylene or ethylene-vinyl acetate, are outside the scope of the present invention. The reason for such an exclusion is that such an elastomer fails to provide the impermeability characteristics obtainable with a predominately C₄ to C₇ isoolefin monomer derived elastomeric polymer, and in particular, an isobutylene based elastomer.

In preparing the DVA, other materials may be blended with either the elastomer or the thermoplastic, before the elastomer and the thermoplastic are combined in the blender or added to the mixer during or after the thermoplastic and elastomer have already been introduced to each other. These other materials may be added to assist with preparation of the DVA or to provide desired physical properties to the DVA. Such additional materials include, but are not limited to, curatives, compatibilizers, extenders and polyamide oligomers or low molecular weight polyamide and other lubricants as described in U.S. Pat. No. 8,021,730 B2 which is incorporated by reference.

With reference to the elastomers of the disclosed invention, “vulcanized” or “cured” refers to the chemical reaction that forms bonds or cross-links between the polymer chains of the elastomer. Curing of the elastomer is generally accomplished by the incorporation of the curing agents and/or accelerators, with the overall mixture of such agents referred to as the cure system or cure package.

Suitable curing components include sulfur, metal oxides, organometallic compounds, radical initiators. Common curatives include ZnO, CaO, MgO, Al2O3, CrO3, FeO, Fe2O3, and NiO. These metal oxides can be used alone or in conjunction with metal stearate complexes (e.g., the stearate salts of Zn, Ca, Mg, and Al), or with stearic acid or other organic acids and either a sulfur compound or an alkyl or aryl peroxide compound or diazo free radical initiators. If peroxides are used, peroxide co-agent commonly used in the art may be employed.

As noted, accelerants (also known as accelerators) may be added with the curative to form a cure package. Suitable curative accelerators include amines, guanidines, thioureas, thiazoles, thiurams, sulfenamides, sulfenimides, thiocarbamates, xanthates, and the like. Numerous accelerators are known in the art and include, but are not limited to, the following: stearic acid, diphenyl guanidine (DPG), tetramethylthiuram disulfide (TMTD), 4,4′-dithiodimorpholine (DTDM), tetrabutylthiuram disulfide (TBTD), 2,2′-benzothiazyl disulfide (MBTS), hexamethylene-1,6-bisthiosulfate disodium salt dihydrate, 2-(morpholinothio) benzothiazole (MBS or MOR), compositions of 90% MOR and 10% MBTS (MOR90), N-tertiarybutyl-2-benzothiazole sulfenamide (TBBS), and N-oxydiethylene thiocarbamyl-N-oxydiethylene sulfonamide (OTOS), zinc 2-ethyl hexanoate (ZEH), N,N′-diethyl thiourea.

In any embodiment of the invention, at least one curing agent is typically present at about 0.1 to about 15 phr; alternatively at about 1.0 to about 10 phr, or at about 1.0 to 3.0 phr, or at about 1.0 to 2.5 phr. If only a single curing agent is used, it is preferably a metal oxide such as zinc oxide.

Components used to compatibilize the viscosity between the elastomer and thermoplastic components may include low molecular weight polyamides, succinic anhydride or maleic anhydride functionalized oligomers wherein the oligomer has a molecular weight in the range of 500 to 5000 and the functionalized oligomer has an anhydride level of a few percent up to about 30 wt %, alternatively 7 to 17 wt %, based on the weight of the functionalized oligomer (AFOs), maleic anhydride grafted polymers having a molecular weight on the order of 10,000 or greater, methacrylate copolymers, tertiary amines and secondary diamines One common group of compatibilizers are maleic anhydride-grafted ethylene-ethyl acrylate copolymers (a solid rubbery material available from Mitsui-DuPont as AR-201 having a melt flow rate of 7 g/10 min measured per JIS K6710). These compounds act to increase the ‘effective’ amount of thermoplastic material in the elastomeric/thermoplastic compound. The amount of additive is selected to achieve the desired viscosity comparison without negatively affecting the characteristics of the DVA. Compounds commonly referred to as plasticizers have also typically been employed as compatibilizers. In any embodiment of the present invention, one commonly used thermoplastic compatibilizer that is not present in the alloy is sulfonamides such as butylbenzenesulfonamide (BBSA).

In any embodiment, the compatibilizer, or combination of compatibilizers, is present in the DVA in amounts ranging from a minimum amount of about 2 phr, 5 phr, 8 phr, or 10 phr to a maximum amount of 12 phr, 15 phr, 20 phr, 25 phr, or 30 phr. The range of compatibilizer(s) may range from any of the above stated minimums to any of the above stated maximums, and the amount of compatibilizer(s) may fall within any of the ranges.

Good morphology can be aided by the selective use of a medium relative viscosity nylon or blends of high and medium relative viscosity nylons and/or low relatively viscosity nylons in combination with other compatibilizers. For balance of durability versus processability low molecular weight nylon, i.e., those having a MW of less than 10,000 are present in the composition in amounts of 0 to 5 wt % of the total composition, preferably 0 to 3 wt %, more preferably 0 wt % of the total composition; expressed alternatively, the amount of low molecular weight nylon in the invention is 0 to 10 wt %, preferably 0 to 5 wt %, more preferably 0 wt %, of the total ‘effective amount’ of thermoplastic components in the compound.

For elastomer-rich compositions, i.e., greater than 55 wt % elastomer in the composition, to obtain the morphology of elastomers dispersed in a thermoplastic resin domain, the viscosity of the thermoplastic plus compatibilizers should be lower than the viscosity of the elastomers. For compatibilizers that graft with the thermoplastic resin during mixing of the DVA, the compatibilizer is added into the mixer/extruder simultaneously with the thermoplastic resin or as the thermoplastic resin begins to melt in the mixer/extruder. As a result of the grafting reaction, the compatibilizer should be fixed within the DVA, and not volatize out during post DVA processing operations such as film blowing or article curing. This is believed to occur with all of the possible thermoplastics, with such grafting occurring more readily when the composition contains polar thermoplastics.

### Film Extrusion

At some point in time after the DVA composition has been formed, for applications wherein the thermoplastic elastomer is to be used as an air barrier layer, the DVA is formed into a film. Film formation may be accomplished by either casting or extruding. While the present invention is directed to extruding of the film, control of the location of the frost line and other inventive aspects disclosed herein for reducing shrinkage of the DVA film may also be applicable for cast films.

The goal of the present invention is the formation of a DVA film wherein the shrinkage of the film width after the passage of a predetermined time after film extrusion is reduced in comparison to shrinkage values for conventional film formation. The film width shrinkage is determined by first measuring the width of the film just after film formation (i.e., new film), measuring the width of the film not earlier than ninety-six (96) hours after the first film width measurement (i.e., the width of the aged film), and calculating the percentage of change in the film width values relative to the new film width. The width of the new film is measured after any necessary expansion of the just formed film, such as expansion of the blown film bubble when extruding the DVA material as discussed further herein (after the film has progressed past the film frost line); if the film is a cast film, expansion of the just formed film may not be a necessary or desired step in the film formation process. This first measurement may be done as or just before the formed film is wound onto a roll for storage or transportation or done as or just before the formed film enters another step in any manufacturing process. The desired film shrinkage is less than 2% of the new film width, less than 1.5% of the new film width, more preferably less than 1% of the new film width, and most preferably less than 0.5% of the new film width.

For the material of the present invention, wherein elastomer is a majority component of the film being produced and the vulcanized elastomer in the DVA has a significant impact of the properties of the film, shrinkage characteristics of the extruded film differ from conventional thermoplastic films. For a DVA, there are the concerns of crystallization of the thermoplastic resin and relaxation of the stored elasticity of the elastomer caused by mastication of the DVA in the film extruder. If the thermoplastic resin crystals become fixed before the stored elasticity is relaxed, the film will experience significant shrinkage of the aged film; as the elastomer compresses or returns to its non-stretched state, it pulls the fixed thermoplastic crystals with it due to the grafting action between the elastomer and the thermoplastic resin.

In accordance with the invention, by reducing the difference in the differential scanning calorimetry crystallization melt temperature and the film recrystallization temperature during the film blowing (also known as ‘under cooling’), the film shrinkage is controlled. Alternatively, this difference may be expressed in terms of the temperature difference between the temperature of the polymer melt exiting the extruder die discharge orifices(s) (i.e. the extrusion die exit film temperature) to the temperature at the film frost line (i.e. the frost line film temperature), wherein a higher frost line due to lower film cooling rate is desirable to reduce post film formation shrinkage. The desired undercooling is achieved by the use of a lower air ring air flow rate (the air flow may be reported as either kilogram per rpm or air pressure in kPa). The cooling rate for given set of operating conditions can be calculated by dividing the temperature difference between the die discharge temperature and the frost line temperature with the amount of film residence time for film to reach from die discharge orifice(s) to the frost line. This residence time is calculated by dividing the distance between the extruder die discharge orifices(s) to the frost line with the film take-up speed.

In accordance with any embodiment of the invention, the film is cooled at a rate of less than 97° C. per second, or less than 90° C. per second, or less than 75° C. per second, or less than 60° C. per second, or less than 40° C. per second. The lower film cooling rates result in a frost line at a relatively higher distance from the extruder die discharge orifice(s). In accordance with any embodiment of the invention, the frost line of the extruded DVA film is at least 135 mm from the extruder die discharge orifice(s), or at least 150 mm from the extruder die discharge orifice(s), or at least 170 mm from the extruder die discharge orifice(s), or at least 180 mm from the extruder die discharge orifice(s) or at least 195 mm from the extruder die discharge orifice(s), or at least 225 mm from the extruder die discharge orifice(s).

In accordance with any embodiment of the invention, a blow up ratio of not more than 2.8 in combination with a draw down ratio of not more than 6.0 is also helpful in achieving the desired reduced shrinkage. Alternatively, the blow up ratio is in the range of 1.9 to 2.8 and the draw down ratio is in the range of 2.8 to 6.0. By using the combination of relatively lower blow-up and lower draw down ratios (compared to conventional thermoplastic film blowing blow-up and draw down ratios), desirable undercooling is achieved and the stored elasticity in the film is reduced. Use of appropriate die design (diameter and die gap) allows for control of both blow-up ratio and draw down ratios for the desired lay flat dimension to manage shrinkage. This results in a lower compression amount or stored elasticity of the elastomer in the DVA, and thereby reducing the shrinkage of the film.

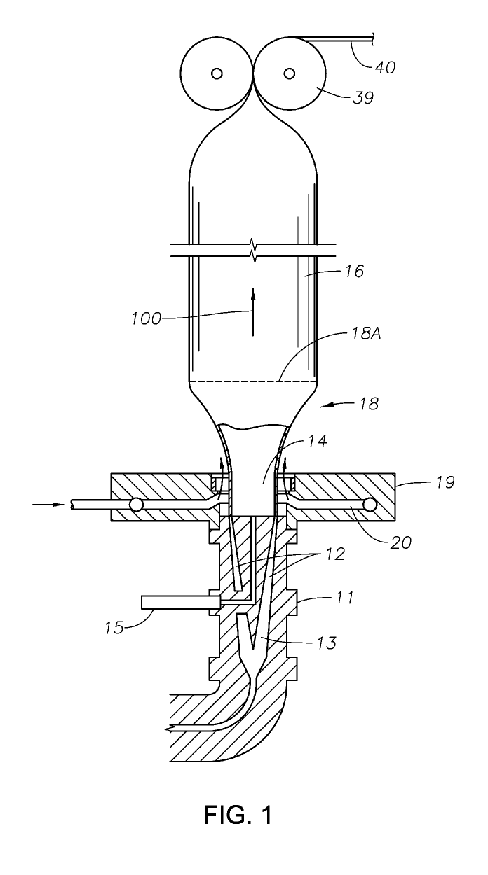

FIG. 1 is illustrative of a conventional thermoplastic resin extruder die useful for extruding the above described DVA into a blown film. The DVA pellets are sent into an extruder generally through a hopper (not illustrated), wherein the pellets are masticated and transformed into a flowable extrudate. The extrudate passes through a channel 13 in the extruder die 11, and into orifice(s) 12 which forms the molten tubular film bubble 14. Via conduit 15, a gas is injected into the interior of the film to expand the film bubble 14. The gas is contained within the film bubble 14 by the die 11 at one end and a pair of nip rolls 39 at the opposing end, thereby providing the force to pull the film 16 away from the die 11 and form a flat two layered film 40; with the film 16 moving in direction 100. FIG. 1 illustrates a vertically upward moving film, however, the orientation of the equipment and film moving direction may be reversed such that the film moves vertically downwards.

Between the die 11 and the nip rolls 39, the film bubble 14 is expanded to maximum diameter and cooled. The bubble 14 is cooled by means of an external air ring 19, where air entering air ring will provide external cooling of the blown film. Some air rings have more than one exit point for air to control its stability and cooling rate. As the film 16 cools, the thermoplastic resin in the film undergoes a phase change to a solid, creating a frost line 18A; due to the phase change, the width of the film bubble 14 at the frost line 18A is at maximum expansion. In accordance with the present invention, it is desired that the stored energy of the dispersed elastomeric particles in the film bubble 14 be released before the moving film reaches the frost line.

While the extrusion mechanism illustrated in FIG. 1 is of a single layer extrudate, it is within the scope of the present invention for the extruded film to be a multiple layer extrusion and/or for the extruded film to be simultaneously coated with an adhesive material. A method and die for co-extruding multiple layers of a DVA alloy and an adhesive are disclosed in US Patent Publication 2013-0157049, the contents therein being incorporated herein by reference.

The extruded film of the present invention has a gauge thickness of 90 to 200 microns.

The invention, accordingly, provides the following embodiments:
A. The process of forming a film of a dynamically vulcanized alloy, the process comprising i) extruding a dynamically vulcanized alloy comprising at least one elastomer dispersed in a continuous domain of thermoplastic resin through at least one extruder die discharge orifice to form an extruded film having an extrusion die exit film temperature, ii) flowing air over the extruded film to reduce the temperature of the extruded film and create a film frost line, and iii) moving the film past he film frost line to complete a film formation process; wherein the temperature of the extruded film is reduced at a cooling rate of less than 97° C. per second and the film frost line of the extruded film is created at a distance from the extruder die discharge orifice of greater than 135 mm;
B. The process of embodiment A wherein the cooling rate is less than 90° C. per second, or less than 75° C. per second, or less than 60° C. per second;
C. The process of embodiment A or B wherein the film is characterized by having a width shrinkage value of less than 2%, or less than 1.5%, or less than 1%, or less than 0.5%, all vales being relative to as measured from the time of film formation to not earlier than 96 hours the first film width measurement;
D. The process of any preceding embodiment A to C or any combination thereof, wherein the blow up ratio is not more than 2.8 and the draw down ratio of the extruded film is not more than 6.0; alternatively, the blow up ratio is in the range of 1.9 to 2.8 and the draw down ratio is in the range of 2.8 to 6.0;
E. The process of any preceding embodiment A to D or any combination thereof, wherein the film is co-extruded with an adhesive coating on at least one surface of the extruded alloy;
F. The process of any preceding embodiment A to E or any combination thereof, wherein the extruded film is a multiple layer extrusion product;
G. The process of any preceding embodiment A to F or any combination thereof, wherein during the distance the extruded film traverses between the extrusion of the film at an extruder die to a frost line of the extruded film, the stored energy of the elastomeric particles in the film is released;
H. The process of any preceding embodiment A to G or any combination thereof, wherein the at least one elastomer is a curable elastomer derived from at least one C₄ to C₇ isoolefin monomer and at least one multiolefin monomer and the at least one thermoplastic resin is a thermoplastic polymer, copolymer or mixture thereof having a Young's modulus of more than 200 MPa at 23° C.;
I. The alloy of any preceding embodiment A to H or any combination thereof, wherein wherein the at least one elastomer is a functionalized elastomer, wherein the elastomer is derived from at least one C₄ to C₇ isoolefin monomer, and the functionalization is derived from at least one of a halogen, an acid, and an ester;
J. The alloy of any preceding embodiment A to I or any combination thereof, wherein the dynamically vulcanized alloy further comprises at least one of a curative, a compatibilizer, a processing aid, and a filler;
K. A film formed by the process of any preceding embodiment A to J or any combination thereof;
L. A film of dynamically vulcanized alloy comprising at least one elastomer dispersed as vulcanized or partially vulcanized particles in a continuous phase of at least one thermoplastic resin, wherein the film is characterized by having a shrinkage of less than 1.5% shrinkage, or less than 1.0% shrinkage, or less than 0.5% shrinkage, the shrinkage percentage being calculated from the difference from the maximum width of the film as measured at the time of film formation and past the film frost line to the maximum width of the film measured not earlier than ninety-six hours after film formation;
M. The film of embodiment K or L, wherein the film is coated with an adhesive layer;
N. The film of any of embodiments K to M, wherein the film is a multi-layer extruded film;
O. The film of any of embodiments K to N or any combination thereof, wherein the at least one elastomer is a curable elastomer derived at least one C₄ to C₇ isoolefin monomer and at least one multiolefin monomer and the at least one thermoplastic resin is a thermoplastic polymer, copolymer or mixture thereof having a Young's modulus of more than 200 MPa at 23° C.;
P. The film of any of embodiments K to 0 or any combination thereof, wherein the at least one elastomer is a functionalized elastomer, wherein the elastomer is derived from at least one C₄ to C₇ isoolefin monomer, and the functionalization is derived from at least one of a halogen, an acid, and an ester;
Q. The film of any of embodiments K to P or any combination thereof, wherein the at least one thermoplastic resin is a mixture of at least two thermoplastic resins;
R. The film of any of embodiments K to Q or any combination thereof, wherein the elastomer is a halogenated butyl rubber or is a copolymer of isobutylene derived units and alkylstyrene derived units;
S. The film of any preceding embodiment K to R or any combination thereof, wherein said elastomer is a copolymer of isobutylene and paramethylstyrene, and is optionally halogenated;
T. The film of any preceding embodiment K to S or any combination thereof, wherein the thermoplastic resin is at least one of polyamides, polyimides, polycarbonates, polyesters, polysulfones, polylactones, polyacetals, acrylonitrile-butadiene-styrene resins, polyphenyleneoxide, polyphenylene sulfide, polystyrene, styrene-acrylonitrile resins, styrene maleic anhydride resins, aromatic polyketones, ethylene vinyl acetates, ethylene vinyl alcohols, and mixtures thereof;
U. The film of any preceding embodiment K to T or any combination thereof, wherein the thermoplastic resin is derived from at least one amine;
V. The film of any preceding embodiment K to U or any combination thereof, wherein the elastomer is present in the alloy in an amount in the range of 55 to 90 wt %;
W. The film of any preceding embodiment K to V or any combination thereof, wherein the elastomer is a halogenated polymer of isobutylene and paramethylstyrene derived units, wherein the polymer comprises 7 to 12 wt % of the paramethylstyrene derived units; and
X. The film of any preceding embodiment K to W or any combination thereof, wherein the alloy comprises 2 to 6 phr of at least one curative.

### Examples

The DVA pellets used for film extrusion were prepared in a twin screw extruder. The components forming the DVA, and the amounts of each, are identified in Table 1 below.

TABLE 1

| | Amount, | | Commercial |
|---|---|---|---|
| Component | phr | Brief Description | Source |
| BIMSM | 100 | Brominated para-methylstyrene-isobutylene | |
| | | copolymer, 5 wt % PMS, 0.75 mol % BrPMS, | |
| | | Mooney viscosity, ML (1 + 8) 125° C. = 45 | |
| Polyamide | 56 | Nylon 6/66, comonomer ratio 80/20, relative | UBE 5024, from |
| copolymer | | viscosity (1% in 96% H₂SO₄ at 23° C.) = 3.4 | UBE Chemical |
| Polyamide | 14 | Nylon 6, relative viscosity (1% in 96% H₂SO₄ | Ultramid B27 |
| homopolymer | | at 23° C.) = 2.7 | |
| PIBSA | 10 | Polyisobutylene succinic anhydride, MW | PIBSA 950 |
| | | before anhydride reaction = 950, viscosity at | from Texas |
| | | 100° C. = 459 cSt, saponification # = 100 mg | Petrochemicals |
| | | KOH/gm | LP |
| Zinc Oxide | 2.0 | | |
| Stabilizer | 0.48 | | |
| package | | | |

The pellets were prepared for film blowing by masticating the pellets in a screw extruder to bring the material to the desired extrusion temperature. The gauge of the film, air pressure values and the die gap were varied to determine the impact on the extrusion parameters on the frost line and undercooling of the film, as well as the resulting shrinkage properties of the aged film. The extrusion rate for all of the runs was 71 kg/hr and for the data in Table 2 below, the lay flat width for the films was 610 mm resulting from a bubble diameter of approximately 410 mm. The data is set forth in Table 2 below.

Reviewing the data, it can be seen that for the two thickest gauges, 200 microns, the aged film shrinkage value is the lowest. This is likely because the greater thickness of the thermoplastic domain works to offset the shrinkage of the elastomer in the film.

As evidenced by the data, as the air pressure to the film is decreased, the film cooling rate decreases, and the frostline height is increased. This results also in lower shrinkage rates of the film. As noted above, the enables the elastomeric material to release its stored energy prior to fixing of the thermoplastic resin domain due to recrystallization of resin structure.

When comparing multiple runs of a single gauge, i.e., the 90 micron gauge runs and the 130 micron gauge runs, it is evidenced that as the air pressure is reduced, the shrinkage characteristics of the film is also reduced.

In viewing the data set for a single air pressure of 1 kPa, with increasing film gauge, the film speed is reduced as the gauge is increased, and the shrinkage rate is reduced.

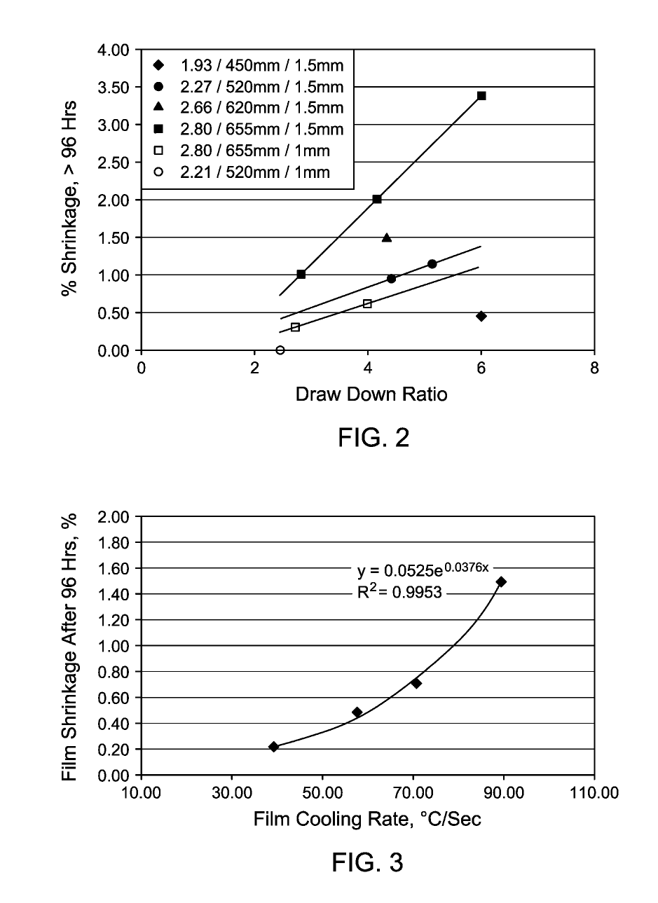

A second set of extrusions runs were performed, wherein the blow up ratio and the draw down ratio was varied for a given lay flat length and die gaps. The shrinkage measured at an extended time of 4 weeks was calculated for each run. The testing parameters and results are set forth in Table 3 and shown graphically in FIGS. 2 and 3.

When graphed, it is evident that for a given blow up ratio, the aged film shrinkage is reduced as the draw down ratio is also reduced. Additionally, for a given blow up ratio, when die gap is reduced, the shrinkage values are surprising reduced.

Applicants have determined that control of both the die diameter and the die lip gap are useful for maintaining a targeted film gauge and to obtain reduced shrinkage of the film. Additional data is presented in Tables 4 and 5 regarding additional extrusion runs.

In Table 4, for runs 20 and 21, the air pressure for expanding the film and air temperature were identical and the blow up ratio and lay flat dimension are very similar. For run 21, an increased line speed run and a relatively larger drawn down ratio, both relative to run 20, resulted in a relatively smaller gauge for the extruded film. The draw down ratio of run 21 is higher than the preferred draw down ratio value of not greater than 6, and the resulting film has an undesirable shrinkage rate of greater than 2.0.

TABLE 2

| | Gauge, | Air Pressure, | Die Melt | Frostline | Frostline Height, mm From | Film Speed, | % Shrinkage, | Film Cooling |
|---|---|---|---|---|---|---|---|---|
| Run | Microns | kPa | Temp, ° C. | Temp, ° C. | Die Discharge | m/min | at ~4 weeks | Rate. ° C./sec |
| 1 | 200 | 0.5 | 244 | 146 | 197 | 4.7 | 0.22 | 38.97 |
| 2 | 90 | 0.87 | 247 | n/a | n/a | 10.2 | 1.12 | n/a |
| 3 | 90 | 1 | 246 | n/a | n/a | 11.5 | 1.25 | n/a |
| 4 | 130 | 1 | 243 | 151 | 187 | 7.0 | 0.49 | 57.40 |
| 5 | 200 | 1 | 251 | n/a | n/a | 5.0 | 0.16 | n/a |
| 6 | 90 | 1.74 | 247 | n/a | n/a | 10.2 | 3.99 | n/a |
| 7 | 130 | 1.74 | 244 | 140 | 172 | 7.0 | 0.71 | 70.54 |
| 8 | 90 | 2 | 248 | n/a | n/a | 11.5 | 1.90 | n/a |
| 9 | 130 | 2.74 | 244 | 124 | 157 | 7.0 | 1.50 | 89.17 |

TABLE 3

| | | | Draw down | | Film Gauge, | |
|---|---|---|---|---|---|---|
| Run | Die Gap, mm | Blow up Ratio | Ratio | Lay Flat, mm | Microns | % Shrinkage |
| 10 | 1.5 | 2.8 | 6 | 653 | 90 | 3.37 |
| 11 | 1.5 | 2.8 | 4.2 | 650 | 130 | 2 |
| 12 | 1.5 | 2.8 | 2.9 | 651 | 190 | 1.23/0.768* |
| 13 | 1.5 | 2.25 | 5.1 | 527 | 130 | 1.14 |
| 14 | 1.5 | 2.27 | 4.4 | 531 | 150 | 0.94 |
| 15 | 1.0 | 2.8 | 4 | 650 | 90 | 0.62 |
| 16 | 1.0 | 2.8 | 2.7 | 660 | 130 | 0.30 |
| 17 | 1.5 | 2.66 | 4.3 | 623 | 130 | 1.77 |
| 18 | 1.5 | 1.93 | 6 | 451 | 130 | 0.44 |
| 19 | 1.0 | 2.21 | 3.48 | 518 | 130 | 0.0 |

*two portions of the sample were measured for shrinkage with an average shrinkage rate of 1

TABLE 4

| | | Air Pressure, kPa; | Blow Up | | Draw Down | Film Gauge, | % Shrinkage, at 4 |
|---|---|---|---|---|---|---|---|
| Run | Line Speed | Temp = 25° C. | Ratio | Lay Flat, mm | Ratio | Microns | Weeks |
| 20 | 6.9 | 1.62 | 2.27 | 532 | 5.08 | 130 | 1.13/0.563** |
| 21 | 10 | 1.62 | 2.23 | 522 | 7.48 | 90 | 3.065 |
| 22 | 6.9 | 1.37 | 2.28 | 533 | 5.07 | 130 | 1.31 |
| 23 | 6 | 1.25 | 2.65 | 621 | 4.35 | 130 | 1.6/2.56** |
| 24 | 5.8 | 1.25 | 2.83 | 663 | 4.08 | 130 | 3.17/3.63** |

For all: screw speed = 15 rpm/100 mm die/lip 150 mm/1.5 mm die gap
**two portions of the sample were measured for shrinkage

TABLE 5

| | | | | | % |
|---|---|---|---|---|---|
| | Blow Up | Draw Down | Lay Flat, | Film Gauge, | Shrinkage, |
| Run | Ratio | Ratio | mm | Microns | at ~4 Weeks |
| 25 | 2.21 | 3.48 | 518 | 130 | 0.0 |
| 26 | 2.60 | 2.95 | 610 | 130 | 0.16 |
| 27 | 2.82 | 2.73 | 660 | 130 | 0.30 |

For all: air pressure was 0.75 kPa, die gap 1.0 mm

Runs 22 to 24 obtained films of identical film gauge, wherein the line speed is reduced from run 22 to run 24. As the line speed is reduced, the blow up ratio was increased and the draw down ratio was decreased. The shrinkage of the extruded films increased with the increased blow up ratio and greater lay flat width.

For runs 25 to 27, the extruder had a 1.0 mm gap and the extruded films had a gauge of 130 microns. As the blow up ratio and draw down ratio values were varying conversely to each other, the lay flat width was increased. All of the shrinkage values as measured at approximately 4 weeks are less than 2.0. Although the blow up ratio value for run 27 is greater than the preferred amount of 2.8, the use of a smaller die gap of 1.0 mm (in comparison to the use of an extruder with a die gap of 1.5 mm) permitted greater control of the extruded film and desirable shrinkage values.

The data set forth in the tables show a shrinkage percentage measured at approximately four weeks following film extrusion, i.e., about 672 hours. While it may be argued that the film continues to contract during the time period from 96 hours to 672, one skilled in the art will appreciate that any rearrangement of the thermoplastic resin crystals in the film material domain and contraction of the dispersed rubber particles in the film material will be substantially complete within 96 hours (4 days) following film extrusion.

While shrinkage of conventional thermoplastic resin films may not be of critical importance when used in further article formation, the present film composition is useful and used as an air barrier layer in laminated and vulcanized articles such as tires. If the film is prepared shortly before (either in the tire manufacturing plant or provided by a just-in-time supplier), if the film has not been formed to eliminate or reduced aged film shrinkage, when incorporated into a tire as an innerliner, due to shrinkage of the film either during building, curing, or post curing, the tire innerliner material may retract. Such a retraction may compromise any splice joints of the innerliner and may also result in cracking of the tire innerliner. Both potential problems can impact and reduce the long term viability of the tire and the air retention characteristics of the tire.

1. A process for forming a film of a dynamically vulcanized alloy, the process comprising:
a. extruding a dynamically vulcanized alloy through at least one extruder die discharge orifice to form an extruded film having an extrusion die exit film temperature, the dynamically vulcanized alloy comprising at least one elastomer dispersed in a continuous domain of at least one thermoplastic resin,
b. flowing air over the extruded film to reduce the temperature of the extruded film and create a film frost line, and
c. moving the film past the film frost line to complete a film formation process,
wherein the temperature of the extruded film is reduced at a cooling rate of less than 97° C. per second and the film frost line of the extruded film is created at a distance of greater than 135 mm from the at least one extruder die discharge orifice.

2. The process of film formation as recited in claim 1, wherein the film is characterized by having a width shrinkage value of less than 2% relative to a width of the extruded film just after completion of the film formation process, the width shrinkage value calculated as the difference in the film width 1) as measured just after completion of the film formation process and 2) as measured not earlier than 96 hours after completion of the film formation process.

3. The process of film formation as recited in claim 1, wherein the blow up ratio is not more than 2.8 and the draw down ratio of the extruded film is not more than 6.0.

4. The process of film formation as recited in claim 1, wherein the film is co-extruded with an adhesive coating on at least one surface of the extruded alloy.

5. The process of film formation as recited in claim 1, wherein the extruded film is a multiple layer extrusion product.

6. The process of film formation as recited in claim 1, wherein during the distance the extruded film traverses between the extruder head to the frost line, the stored energy of the elastomeric particles in the film is released.

7. The process of film formation as recited in claim 1, wherein the at least one elastomer is a curable elastomer derived at least one C₄ to C₇ isoolefin monomer and at least one multiolefin monomer and the at least one thermoplastic resin is a thermoplastic polymer, copolymer or mixture thereof having a Young's modulus of more than 200 MPa at 23° C.

8. The process of film formation as recited in claim 1, wherein the at least one elastomer is a functionalized elastomer, wherein the elastomer is derived from at least one C₄ to C₇ isoolefin monomer, and the functionalization is derived from at least one of a halogen, an acid, and an ester.

9. The process of film formation as recited in claim 1, wherein the dynamically vulcanized alloy further comprises of at least one of a curative, a compatibilizer, a processing aid, and a filler.

10. A film formed by the process as recited in claim 1.

11. A film of dynamically vulcanized alloy comprising at least one elastomer dispersed as vulcanized or partially vulcanized particles in a continuous phase of at least one thermoplastic resin,
wherein the film is characterized by having a shrinkage of less than 1.5%, the shrinkage percentage calculated from the maximum width of the film as measured at the time of a formation of the film to not earlier than ninety-six hours after completion of formation of the film.

12. The film as recited in claim 11, wherein the film is coated with an adhesive layer.

13. The film as recited in claim 11, wherein the film is a multi-layer extruded film.

14. The film as recited in claim 11, wherein the at least one elastomer is a curable elastomer derived from at least one C₄ to C₇ isoolefin monomer and at least one multiolefin monomer and the at least one thermoplastic resin is a thermoplastic polymer, copolymer or mixture thereof having a Young's modulus of more than 200 MPa at 23° C.

15. The film as recited in claim 11, wherein the at least one elastomer is a functionalized elastomer, wherein the elastomer is derived from at least one C₄ to C₇ isoolefin monomer, and the functionalization is derived from at least one of a halogen, an acid, and an ester.

16. The film as recited in claim 11, wherein the at least one thermoplastic resin is a mixture of at least two thermoplastic resins.

17. The film as recited in claim 11, wherein the elastomer is a halogenated butyl rubber or is a copolymer of isobutylene derived units and alkylstyrene derived units.

18. The film as recited in claim 11, wherein the thermoplastic resin is at least one of polyamides, polyimides, polycarbonates, polyesters, polysulfones, polylactones, polyacetals, acrylonitrile-butadiene-styrene resins, polyphenyleneoxide, polyphenylene sulfide, polystyrene, styrene-acrylonitrile resins, styrene maleic anhydride resins, aromatic polyketones, ethylene vinyl acetates, ethylene vinyl alcohols, and mixtures thereof.

19. The film as recited in claim 11, wherein the elastomer is present in the alloy in an amount in the range of 55 to 90 wt %.
